(19) United States
(12) Patent Application Publication
(10) Pub. No.: US 2020/0334565 A1
(43) Pub. Date: Oct. 22, 2020

(54) MAXIMUM ENTROPY REGULARISED MULTI-GOAL REINFORCEMENT LEARNING

(71) Applicant: Siemens Aktiengesellschaft, Munchen (DE)

(72) Inventors: Volker Tresp, München (DE); Rui Zhao, München (DE)

(21) Appl. No.: 16/385,209

(22) Filed: Apr. 16, 2019

(51) Int. Cl. G06N 20/00; G06N 3/08; G06N 5/04

(52) U.S. Cl. CPC G06N 20/00; G06N 5/042; G06N 3/084

(57) ABSTRACT

The present invention is related to a computer-implemented method of training artificial intelligence (AI) systems or rather agents (Maximum Entropy Regularised multi-goal Reinforcement Learning), in particular, an AI system/agent for controlling a technical system. By constructing a prioritised sampling distribution q(ô^{g}) with a higher entropy [symbol] _{q}(Ô^{g}) than the distribution p(ô^{g}) of goal state trajectories ô^{g} and sampling the goal state trajectories ô^{g} with the prioritised sampling distribution q(ô^{g}) the AI system/agent is trained to achieve unseen goals by learning from diverse achieved goal states uniformly.

### FIELD OF TECHNOLOGY

The present invention is related to a computer-implemented method of training artificial intelligence (AI) systems or rather agents (Maximum Entropy Regularised multi-goal Reinforcement Learning), in particular, an AI system/agent for controlling a technical system.

### BACKGROUND

AI systems like Neuronal Networks (NN) need to be trained in order to learn how to accomplish certain tasks like locomotion and robot manipulation (e.g. manipulation of a robot arm having several joints).

Reinforcement Learning (RL) combined with Deep Learning (DL) lead to great successes in various tasks, such as learning autonomously to accomplish different robotic tasks. One of the biggest challenges in RL is to make the agent learn sample-efficiently in applications with sparse rewards. Recent RL algorithms, such as Deep Deterministic Policy Gradient (DDPG), enable the agent to learn continuous control, such as manipulation and locomotion. Further, UVFAs generalise not just over states but also over goals. Consequently, a UVFA method extends value functions (Q-functions) to multiple goals. Furthermore, to make the agent learn faster in the sparse reward settings Hindsight Experience Replay (HER) encourages the agent to learn from whatever goal states it has achieved. The combined use of DDPG and HER lets the agent learn to accomplish more complex robot manipulation tasks.

However, there is still a huge gap between the learning efficiency of humans and RL agents. In most cases, an RL agent needs millions of samples before it is able to solve the tasks, while humans only need a few samples. A concept of maximum entropy is used to encourage exploration during training. Soft-Q learning learns a deep energy-based policy with the maximum entropy of actions for each state and encourages the agent to learn all the policies that lead to the optimum. Furthermore, Soft Actor-Critic demonstrates a better performance while showing compositional ability and robustness of the maximum entropy policy in locomotion and robot manipulation task. The agent aims to maximise the expected reward while also maximising the entropy to succeed at the task while acting as randomly as possible. Based on maximum entropy policies the agent is able to develop diverse skills by solely maximising an information theoretic objective without any reward function. For multi-goal and multi-task learning the diversity of training sets helps the agent to transfer skills to unseen goals and tasks. The variability of training samples mitigate over-fitting and helps the model to better generalise.

### SUMMARY

It is an objective of the present invention to solve or at least alleviate the above-mentioned problems. Therefore, a computer-implemented method of training artificial intelligence (AI) systems according to independent claim 1 as well as a corresponding computer-readable medium and a computer system according to the further independent claims. Embodiments and refinements of the present invention are subject of the respective dependent claims.

According to a first aspect of the present invention a computer-implemented method of training artificial intelligence (AI) systems or rather agents (Maximum Entropy Regularised multi-goal Reinforcement Learning) comprises the iterative step of sampling a real goal g^{e} and for each episode of each epoch of the training the iterative steps of sampling an action aₜ, stepping an environment, updating an replay buffer [symbol] , constructing a prioritised sampling distribution q(τ^{g}), sampling goal state trajectories τ^{g} [small Tau] and updating a single-goal conditioned behaviour policy θ [small Theta] as well as after each episode for each epoch of the training the step of updating a density model Φ [capital Phi]. In the step of sampling the real goal g^{e}, the real goal g^{e} of a multitude of real goals G^{e} with a probability p(g^{e}) and an initial state s₀ with a probability of p(s₀) are sampled. In the step of sampling an action aₜ, an action aₜ from the single-goal conditioned behaviour policy θ that is represented by a Universal Value Function Approximator (UVFA) is sampled. In the step of stepping the environment, the environment is stepped for a new state sₜ₊₁ with the sampled action aₜ. In the step of updating the replay buffer [symbol] , the replay buffer [symbol] that comprises a distribution p(τ^{g}) of goal state trajectories τ^{g} is updated with the current state sₜ and the current action aₜ. The goal state trajectories τ^{g} contain pairs of states sₜ from a multitude of states Sₜ and corresponding actions aₜ from a multitude of actions Aₜ. In the step of constructing the prioritised sampling distribution q(τ^{g}), the prioritised sampling distribution q(τ^{g}) is stepped with a higher entropy [symbol] _{q}(T^{g}) than the distribution p(τ^{g}) of goal state trajectories τ^{g} in the replay buffer [symbol] . In the step of sampling the goal state trajectories τ^{g}, the goal state trajectories τ^{g} are sampled with the prioritised sampling distribution q(τ^{g}) and a current density model Φ (q(τ^{g}|Φ)). In the step of updating the single-goal conditioned behaviour policy θ, the single-goal conditioned behaviour policy θ is updated to a maximum of an Energy [symbol] _{q} of a reward r for the states Sₜ and real goals G^{e} (max [symbol] _{q}[r(Sₜ,G^{e}]). After the previous steps are iteratively executed for each episode of the current epoch, in the step of updating the density model Φ, the density model Φ is updated (in each epoch). All iterative steps are executed as long as the computer-implemented method has not converged.

According to a second aspect of the present invention a computer program comprises instructions which, when the program is executed by a computer, cause the computer to carry out the steps of the method according to the first aspect of the present invention.

According to a third aspect of the present invention a computer-readable medium has stored thereon the computer program according to the second aspect of the present invention.

According to a fourth aspect of the present invention a data processing system comprises means for carrying out the steps of the method according to the first aspect of the present invention.

In multi-goal RL, the agent learns to achieve multiple goals with a single-goal conditioned behaviour policy. Such a single-goal conditioned behaviour policy is represented with the UVFA. For off-policy approaches, the agent collects trajectories comprising states and corresponding actions into the replay buffer [symbol] . During training, the trajectories are selected randomly from the replay buffer [symbol] for replay. However, in common experience replay methods, the uniformly sampled trajectories are biased towards the behaviour policies, with respect to the achieved goal states. In other words, in common experience replay methods the achieved goals in the replay buffer [symbol] are often biased because of the behaviour policies. From a Bayesian perspective, when there is no prior knowledge of the target goal distribution, the agent should rather learn from different achieved goals uniformly. Consider training a robot arm to reach a certain point in a space. At the beginning, the agent samples trajectories with a random policy. The sampled trajectories are centred around the initial position of the robot arm. Therefore, the distribution of achieved goals, i.e. positions of the robot arm, is similar to a Gaussian distribution around the initial position, which is non-uniform. Sampling from such a distribution is biased towards the current policies. However, from the Bayesian point of view the agent should learn from these achieved goals uniformly, when there is no prior knowledge of the target goal distribution. To correct this bias, the present invention provides a different objective, which combines maximum entropy and the multi-goal RI, objective. The multi-goal RL objective of the present invention uses entropy as a regulariser to encourage the agent to traverse diverse goal states. Furthermore, a safe lower bound for optimisation is provided.

The computer-implemented method implements a Maximum Entropy Regularised (MER) multigoal Reinforcement Learning (RL) objective based on weighted entropy. This MER multi-goal RL objective encourages an agent to maximise the expected return as well as to achieve more diverse goals. The MER multi-goal RL objective is regularised via a Maximum Entropy based Prioritisation (MEP) framework. In other words, maximum entropy is combined with multi-goal RL to facilitate the agent to achieve unseen goals by learning from diverse achieved goals uniformly during training. The MEP framework may further be combined with Deep Deterministic Policy Gradient (DDPG) with or without Hindsight Experience Replay (HER).

The present invention regards multi-goal reinforcement learning tasks like robotic (simulation) scenarios (for example Open AI Gym which comprises six tasks including push, slide and pick & place with a robot arm as well as hand manipulation of a block, egg and pen). In the present invention the goals g may be the desired positions and the orientations of an object in robotic (simulation) scenarios. Specifically, g^{e}, where e stands for environment, denotes the real goal, which serves as the input from an environment. A state s comprises two sub-vectors, one achieved goal state s^{g} (e.g. position and orientation of the object being manipulated) and one context state s^{c}, i.e.

s=(s^{g}∥s^{c})

where ∥ denotes concatenation. The context state s^{c} contains the rest of the state information (e.g. linear and angular velocities of all robot joints and of the object). Achieved goals g^{s} can be represented by states leading to the concept of achieved goal states. In the present invention

g^{s}=s^{g}

is defined to represent an achieved goal as an achieved goal state g^{s}, which has the same dimension as the real goal g^{e} from the environment. The real (environmental) goals g^{e} can be substituted with the achieved goal states g^{s} to facilitate learning (i.e. goal relabeling in HER). A trajectory consisting solely of achieved goal states g^{s} is represented as τ^{g}, i.e.

τ^{g}=(g₀^{s}, . . . ,g_{T}^{s})

The present invention considers sparse rewards r. There is a tolerated range between the desired goal states and the achieved goal states. If the object is not in the tolerated range of the real goal, the agent receives a reward signal −1 for each transition; otherwise, the agent receives a reward signal 0. In multi-goal settings, the agent receives the real goal g^{e} and the state input

s=(s^{g}∥s^{c})

Thereby, a single-goal conditioned policy is trained to generalise to different real goals g^{e} well.

The agent interacts with the environment. The environment is fully observable, including a set S of states s, a set A of actions a, a distribution of initial states p(s₀), transition probabilities p(sₜ₊₁|sₜ, aₜ), a reward function r: S×A→ [symbol] and a discount factory γϵ[0,1].

UVFA essentially generalises the value functions (Q-functions) to multiple achieved goal states g^{s} where Q-values depend not only on state-action pairs (sₜ, aₜ), but also on the achieved goal states g^{s}.

Weighted entropy is an extension of Shannon entropy. The definition of weighted entropy is given by

$${ℋ}_{p}^{w} = - {\sum }_{k = 1}^{K} {w}_{k} {p}_{k} log {p}_{k} \qquad ( 1 )$$

where wₖ is the weight of the elementary event and pₖ is the probability of the elementary event.

In the following the MER multi-goal RL objective and the MEP framework of the present invention are formally described and mathematically derived.

The MER multi-goal RL is considered as goal-conditioned policy learning. Random variables are denoted with upper case letters and the values of random variables with corresponding lower case letters. Let Val(X)=x denote the set of valid values to a random variable X. p(x) is used to denote the probability function of the random variable X. The agent receives a goal g^{e}ϵVal(G^{e}) at the beginning of an episode. The agent interacts with the environment for T timesteps. At each timestep t, the agent observes a state sₜϵVal (Sₜ) and performs an action aₜϵVal(Aₜ). The agent also receives the reward r conditioned on the input real goal g^{e}, i.e. r(sₜ, g^{e})ϵ [symbol] . A trajectory is denoted by

τ=(s₁,a₁,s₂,a₂, . . . ,s_{T-1},a_{T-1},s_{T})

where τϵVal (T[capital Tau]). The probability p(τ|g^{e}, θ) of trajectory τ, given goal g^{e} and a single-goal conditioned behaviour policy parameterised by θϵVal(Θ) [capital Phi] is given by

$$p ( τ \vert {g}^{e} , θ ) = p ( {s}_{1} ) {\prod }_{t = 1}^{T - 1} p ( {a}_{t} \vert {s}_{t} , {g}^{e} , θ ) p ( {s}_{t + 1} \vert {s}_{t + 1} , {a}_{t} )$$

The transition probability p(sₜ₊₁|sₜ₊₁, aₜ) states that the probability of a state transition given an action aₜ is independent of the real goal g^{e}, which is denoted with Sₜ₊₁ [symbol] G^{e}|Sₜ,Aₜ. For every τ, g^{e} and θ, it is also assumed that p(τ|g^{e}, θ) is non-zero. The expected return of a policy parameterised by θ is given by

$$η [ small Eta ] ( θ ) = 𝔼 [ {\sum }_{t = 1}^{T} r ( {S}_{t} , {G}^{e} ) \vert θ ] = {\sum }_{{g}^{e}} p ( {g}^{e} ) {\sum }_{τ} p ( τ \vert {g}^{e} , θ ) {\sum }_{t = 1}^{T} r ( {s}_{t} , {g}^{e} ) \qquad ( 2 )$$

where [symbol] is an Expectation of the return (accumulated rewards) of the single-goal conditioned behaviour policy θ.

Off-policy RL methods use experience replay to trade bias over variance and potentially improve the sample-efficiency. In the off-policy case, the objective, equation (2), is given by

$${η}^{ℛ} ( θ ) = {\sum }_{τ , {g}^{e}} {p}_{ℛ} ( {τ}^{g} , {g}^{e} \vert θ ) {\sum }_{t = 1}^{T} r ( {s}_{t} , {g}^{e} ) \qquad ( 3 )$$

where [symbol] denotes the replay buffer. Commonly, the trajectories τ are randomly sampled from the replay buffer [symbol] . As in the common case the trajectories in the replay buffer [symbol] are often imbalanced with respect to the achieved goal states g^{s} in the goal state trajectory τ^{G}, in MER multigoal RL the multi-goal RL method is regularised by the MEP framework to improve performance.

In MER multi-goal RL the agent is encouraged to traverse diverse goal state trajectories τ^{G} and at the same time to maximise the expected return. A respective reward weighted entropy objective for the MER multi-goal RL is given by

$${η}^{ℋ} ( θ ) = {ℋ}_{p}^{w} ( {T}^{g} ) = {𝔼}_{p} [ log \frac{1}{p ( {τ}^{g} )} {\sum }_{t = 1}^{T} r ( {S}_{t} , {G}^{e} ) \vert θ ] \qquad ( 4 )$$

For simplicity p(τ^{g}) is used to represent [symbol] (τ^{g},g^{e}|θ), which is the occurrence probability of the goal state trajectory τ^{g}. The expectation operation is with respect to p(τ^{g}) as well, so the proposed objective is the weighted entropy of the goal state trajectory τ^{g}, which is denoted as [symbol] ₚ^{w}(T^{g}), where the weight w is the accumulated reward Σₜ₌₁^{T}r(Sₜ, G^{e}). The objective function, equation (4), has two interpretations. The first interpretation is to maximise the weighted expected return, where the rare goal state trajectories τ^{g} have larger weights w. Note that when all goal state trajectories occur uniformly, this weighting mechanism has no effect. The second interpretation is to maximise a reward weighted entropy, where the more rewarded goal state trajectories τ^{g} have higher weights w. This objective encourages the agent to learn how to achieve diverse goal states g^{s}, as well as to maximise the expected return. In equation (4), the weight

$$log \frac{1}{p ( {τ}^{g} )}$$

is unbounded, which makes the training of the universal function approximator unstable. Therefore, a safe surrogate objective [symbol] (θ) is provided, which is essentially a lower bound of the original reward weighted entropy objective [symbol] (θ).

To construct the safe surrogate objective [symbol] (θ), goal state trajectories τ^{g} from the replay buffer [symbol] are sampled with a prioritised sampling distribution or rather proposal probability density function/distribution

$$q ( {τ}^{g} ) = \frac{1}{Z} p ( {τ}^{g} ) ( 1 - p ( {τ}^{g} ) ) . p ( {τ}^{g} )$$

represents the density function/distribution of the goal state trajectories in the replay buffer [symbol] . The surrogate objective [symbol] (θ) is a lower bound of the original reward weighted entropy objective [symbol] (θ), i.e. [symbol] (θ)≤ [symbol] (θ), where

$$\begin{matrix}{η}^{ℒ} ( θ ) = Z \cdot {𝔼}_{q} [ {\sum }_{t = 1}^{T} r ( {S}_{t} , {G}^{e} ) \vert θ ] & ( 5 ) \\ q ( {τ}^{g} ) = \frac{1}{Z} p ( {τ}^{g} ) ( 1 - p ( {τ}^{g} ) ) & ( 6 )\end{matrix}$$

Z is the normalisation factor for q(ô^{g}).

To optimise the surrogate objective, equation (5), the optimisation process is cast into the MEP framework or rather prioritised sampling framework. At each iteration first the prioritised sampling distribution/proposal probability density function q(ô^{g}) is constructed, which has an equal or higher entropy than p(ô^{g}). This ensures that the agent learns from a more diverse goal state distribution. The entropy with respect to q(ô^{g}) is higher than the entropy with respect to p(ô^{g}):

The probability density function of achieved goal states in the replay buffer [symbol] is p(ô^{g}), where

$$p ( {\hat{o}}_{i}^{g} ) ∈ ( 0 , 1 ) and {\sum }_{i = 1}^{N} p ( {\hat{o}}_{i}^{g} ) = 1 \qquad ( 7 )$$

The prioritised sampling distribution or rather proposal probability density function is defined as

$$q ( {\hat{o}}_{i}^{g} ) = \frac{1}{Z} p ( {\hat{o}}_{i}^{g} ) ( 1 - p ( {\hat{o}}_{i}^{g} ) ) , where {\sum }_{i = 1}^{N} q ( {\hat{o}}_{i}^{g} ) = 1 \qquad ( 8 )$$

The proposal goal probability density function (distribution) q(ôᵢ^{g}) has an equal or higher entropy than the probability density function of achieved goal states p(ô^{g}) in the replay buffer

[symbol]

[symbol]

_{q}(Ô^{g})− [symbol] ₚ(Ô^{g})≥0 (9)

In order to optimise the surrogate objective with, equation (5), prioritised sampling, the probability distribution of a goal state trajectory p(ô^{g}) needs to be known. A Latent Variable Model (LVM) is used to model the underlying distribution of p(ô^{g}) because LVM is suitable for modelling complex distributions. Specifically p(ô^{g}|zₖ) is used to denote the latent variable conditioned goal state trajectory probability density function (distribution), which is assumed as Gaussians. zₖ is the k-th latent variable, where kϵ{1, . . . , K} and K is the number of the latent variables. The resulting model is a Mixture of Gaussians (MoG), mathematically:

$$p ( {\hat{o}}^{g} \vert \ddot{O} ) = \frac{1}{Z} {\sum }_{i = k}^{K} {c}_{i} 𝒩 ( {\hat{o}}^{g} \vert {{1}^{‘}}_{i} , {Σ}_{i} ) \qquad ( 10 )$$

where each Gaussian (ô^{g}| [symbol] ᵢ, Σₜ) has its own mean [symbol] ₜ and covariance Σₜ, cᵢ are the mixing coefficients and Z is the partition function. The model parameter Ö includes all mean covariance Σᵢ, and mixing coefficients cᵢ. In prioritised sampling, the complementary predictive density of a goal state trajectory ô^{g} is used as the priority, which is given by

p̅(ô^{g}|Ö)∝1−p(ô^{g}|Ö) (11)

The complementary predictive density p(ô^{g}|Ö) describes the likelihood that a goal state trajectory ô^{g} occurs rarely in the replay buffer [symbol] . A high complementary predictive density p̅(ô^{g}|Ö) corresponds to a rare occurrence of the goal state trajectory ô^{g}. These rare goal state trajectories ô^{g} are oversampled during replay to increase the entropy of the training distribution. Therefore, the complementary predictive density p̅(ô^{g}|Ô) is used to construct the proposal probability density function q(ô^{g}) as a joint distribution

q(ô^{g})∝p̅(ô^{g}|Ö)p(ô^{g})∝(1−p(ô^{g}|Ö))p(ô^{g})≈p(ô^{g})−p(ô^{g})² (12)

With prioritised sampling, the agent learns to maximise the return of a more diverse goal state distribution. When the agent replays the samples, it first ranks all the goal state trajectories ô^{g} with respect to their proposal distribution p(ô^{g}), and then uses the ranking number directly as the probability for sampling. This means that rare achieved goal states g^{s} have high ranking numbers and, equivalently, have higher priorities to be replayed. Here the ranking is used instead of the density directly. The reason is that the rank-based variant is more robust because it is neither affected by outliers nor by density magnitudes. Furthermore, its heavy-tail property also guarantees that samples will be diverse. Mathematically, the probability of a trajectory to be replayed after the prioritisation is:

$$q ( {\hat{o}}_{i}^{g} ) = \frac{rank ( q ( {\hat{o}}_{i}^{g} ) )}{{\sum }_{n = 1}^{N} q ( {\hat{o}}_{n}^{g} )} \qquad ( 13 )$$

where N is the total number of goal state trajectories ô^{g} in the replay buffer [symbol] , and rank (⋅) is the ranking function.

Thus, MER multi-goal RL is provided to enable RL agents to learn more efficiently in multi-goal tasks. Further, a goal entropy term is integrated into the reward weighted entropy objective (expected return objective), equation (4). To maximise the reward weighted entropy objective, equation (4), a surrogate objective is derived, i.e. a lower bound of the original reward weighted entropy objective. Prioritised sampling based on a higher entropy proposal distribution is used in each iteration and off-policy RL methods are used to maximise the expected return. This framework is implemented as the MEP framework.

In the following an exemplary algorithm according to the present invention is given in pseudocode:

```
while not converged do
  Sample goal g^{e} ~ p(g^{e}) and initial state s₀ ~ p(s₀)
  for steps per epoch do
    for steps per episode do
        Sample action aₜ ~ p(aₜ|sₜ, g^{e}, è) from single-goal conditioned
      behaviour policy è
      Step environment sₜ₊₁ ~ p(sₜ₊₁|sₜ, aₜ)
      Update replay buffer [symbol]
      Construct prioritized sampling distribution q(ô^{g}) ∝
      (1 − p(ô^{g}|Ö))p(ô^{g}) with higher [symbol] _{q}(Ô^{g})
      Sample goal state trajectories ô^{g} ~ q(ô^{g}|Ö)
      Update single-goal conditioned behaviour policy è to
      max [symbol] _{q} [r(Sₜ, G^{e})]
    end for
    Update density model Ö
  end for
end while
```

The iteration may continue until the method has converged to the optimal policy or until a predefined criterion is met (e.g. number of epochs).

The computer-implemented method according to the first aspect of the present invention (MER multi-goal RI, method) improves the performance and sample-efficiency in training AI systems for a fair trade-off of computational time.

According to a refinement of the present invention the step of updating (6) the goal conditioned behaviour policy é is based on a Deep Deterministic Policy Gradient (DDPG) method and/or on a Hindsight Experience Replay (HER) method.

For continuous control tasks DDPG shows promising performance, which is essentially an off-policy actor-critic method. More details regarding DDPG??? Thereby the ideas underlying the success of Deep Q-Learning are adapted to the continuous action domain. The actor-critic, model-free method is based on the deterministic policy gradient that can operate over continuous action spaces. Using the same learning algorithm, network architecture and hyper-parameters allows for robustly solving tasks, including classic problems such as cartpole swing-up, dexterous manipulation, legged locomotion and car driving. The method is able to find policies whose performance is competitive with those found by a planning algorithm with full access to the dynamics of the domain and its derivatives.

In particular for robotic tasks, if the goal is challenging and the reward is sparse, the agent could perform badly for a long time before learning anything. HER encourages the agent to learn from whatever goal states it has achieved. HER makes training possible in challenging robotic tasks via goal relabeling, i.e. randomly substituting real goals g^{e} with achieved goals g^{s}. Dealing with sparse rewards is one of the biggest challenges in Reinforcement Learning (RL). HER allows sample-efficient learning from rewards which are sparse and binary and therefore avoid the need for complicated reward engineering. It can be combined with an arbitrary off-policy RL algorithm and may be seen as a form of implicit curriculum.

In the following an exemplary algorithm according to the refinement of the present invention is given in pseudo-code:

```
while not converged do
  Sample goal g^{e} ~ p(g^{e}) and initial state s₀ ~ p(s₀)
  for steps per epoch do
    for steps per episode do
        Sample action aₜ ~ p(aₜ|sₜ, g^{e}, è) from single-goal conditioned
      behaviour policy è
      Step environment sₜ₊₁ ~ p(sₜ₊₁|sₜ, aₜ)
      Update replay buffer [symbol]
      Construct prioritized sampling distribution q(ô^{g}) ∝
      (1 − p(ô^{g}|Ö))p(ô^{g}) with higher [symbol] _{q}(Ô^{g})
      Sample goal state trajectories ô^{g} ~ q(ô^{g}|Ö)
      Update single-goal conditioned behaviour policy è to
      max [symbol] _{g} [r(Sₜ, G^{e})] via DDPG, HER
    end for
    Update density model Ö
  end for
end while
```

With DDPG and especially with DDPG and HER the performance in continuous control tasks (e.g. robotic (simulation) scenarios) can be improved.

### BRIEF DESCRIPTION

The present invention and its technical field are subsequently explained in further detail by exemplary embodiments shown in the drawings. The exemplary embodiments only conduce better understanding of the present invention and in no case are to be construed as limiting for the scope of the present invention. Particularly, it is possible to extract aspects of the subject-matter described in the figures and to combine it with other components and findings of the present description or figures, if not explicitly described differently. Equal reference signs refer to the same objects, such that explanations from other figures may be supplementally used.

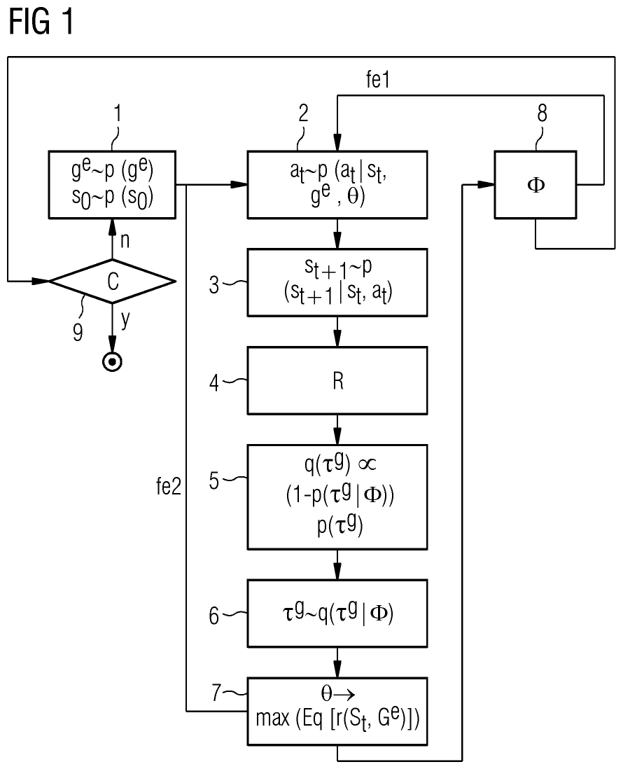

FIG. 1 shows a schematic flow chart of the computer-implemented method/computer program according to the first/second aspect of the present invention.

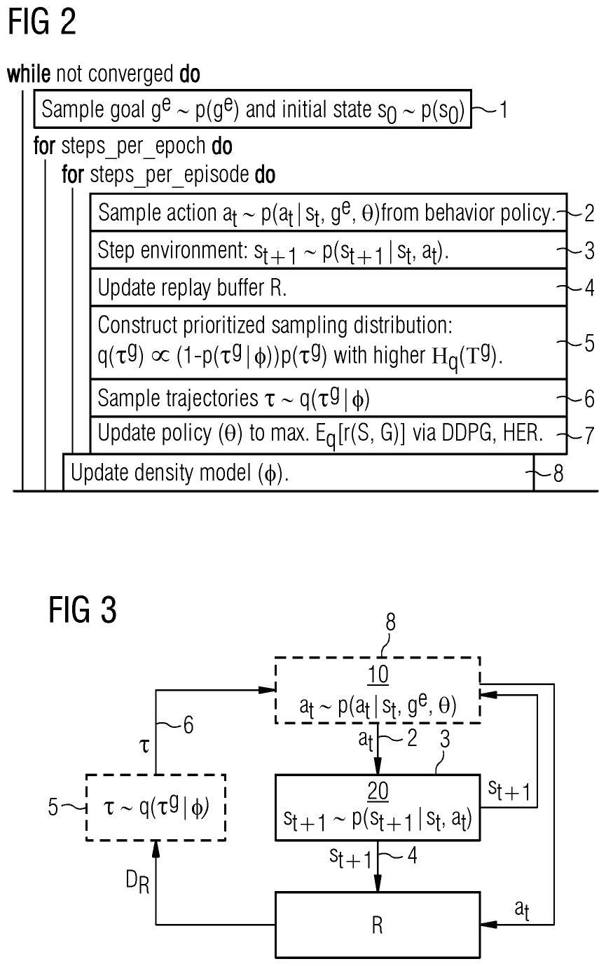

FIG. 2 shows a schematic algorithm of the computer-implemented method/computer program according to the first/second aspect of the present invention.

FIG. 3 shows a schematic flow chart of the steps during an episode of the training with computer-implemented method/computer program according to the first/second aspect of the present invention.

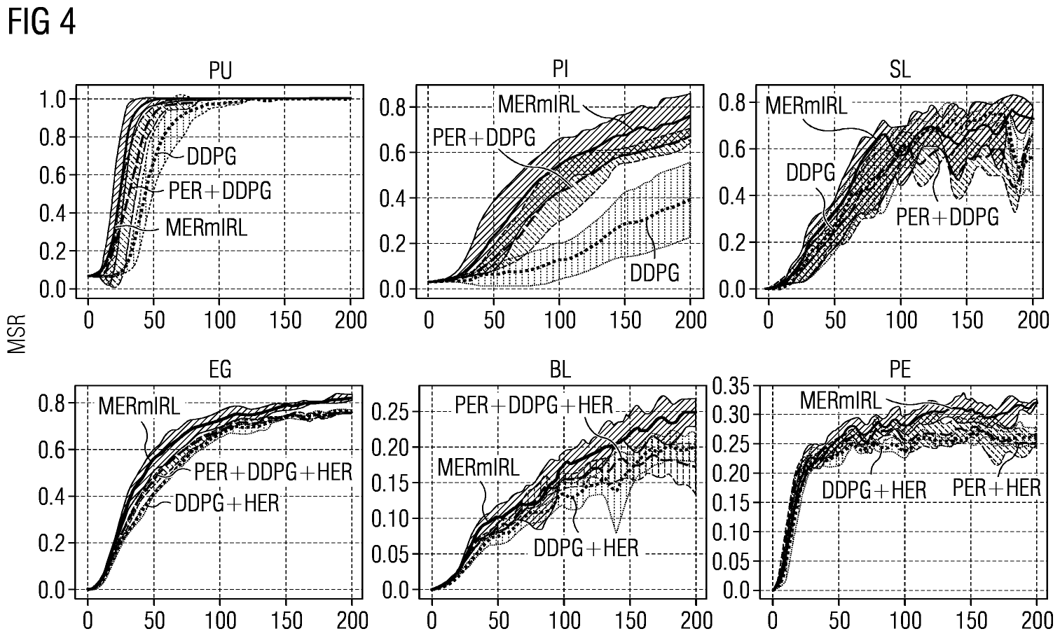

FIG. 4 shows a schematic diagram of a performance test of the computer-implemented method according to the first aspect of the present invention.

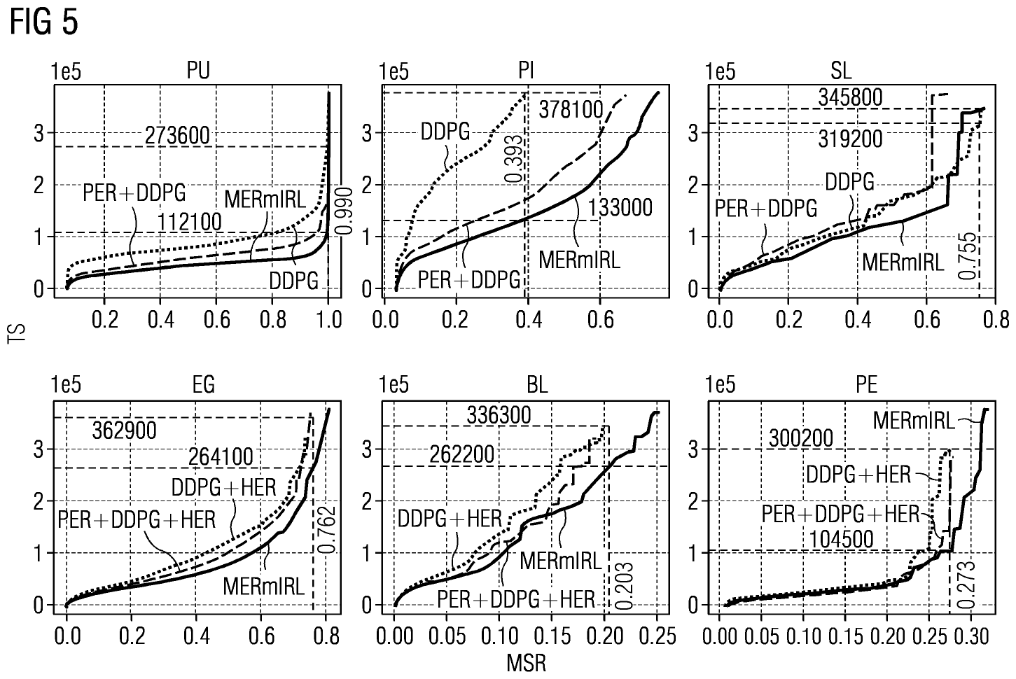

FIG. 5 shows a schematic diagram of a sample-efficiency test of the computer-implemented method according to the first aspect of the present invention.

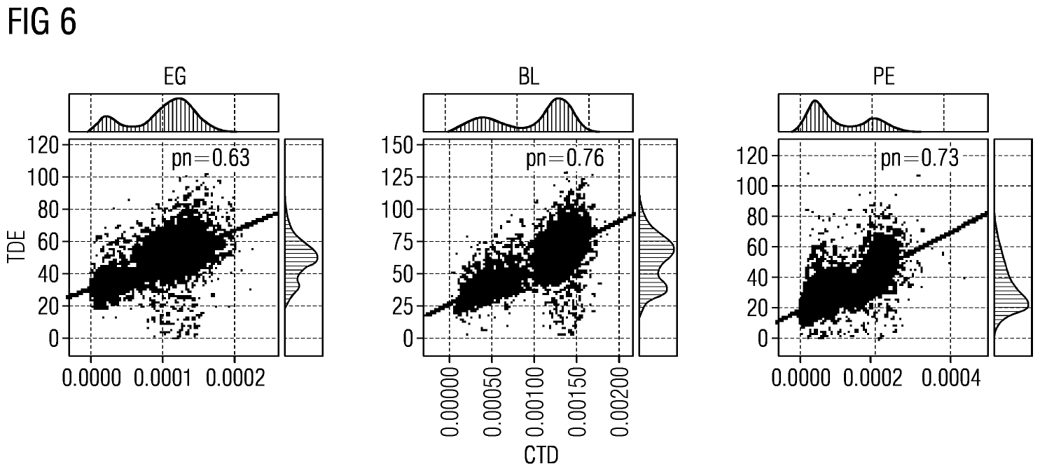

FIG. 6 shows a schematic diagram of TD-errors during training with the computer-implemented method according to the first aspect of the present invention.

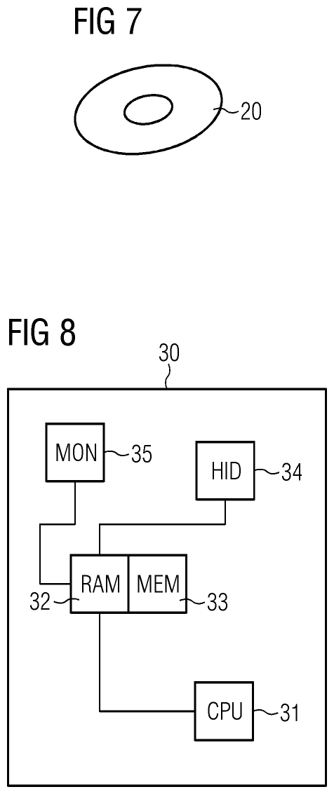

FIG. 7 shows a schematic view of the computer-readable medium according to the third aspect of the present invention.

FIG. 8 shows a schematic view of the data processing system according to the fourth aspect of the present invention.

### DETAILED DESCRIPTION

In FIG. 1 a flow chart of an embodiment of the computer-implemented method according to the first aspect of the present invention and of the computer program according to the second aspect of the present invention is exemplarily depicted.

In FIG. 2 a corresponding algorithm of the embodiment of FIG. 1 is schematically depicted.

As depicted in FIGS. 1 and 2 the computer-implemented method of training an artificial intelligence (AI) system (MER multi-goal RL method) and the corresponding computer program comprise the iterative step of:
sampling 1 a real goal g^{e}; and
   for each episode of each epoch fe2 of the training the iterative steps of:
sampling 2 an action aₜ;
stepping 3 an environment;
updating 4 an replay buffer [symbol] ;
constructing 5 a prioritised sampling distribution q(ô^{g});
sampling 6 goal state trajectories ô^{g}; and
updating 7 a single-goal conditioned behaviour policy é; as well as after each episode for each epoch fe1 of the training the step of:
updating 8 a density model Ö.

In the step of sampling 1 the real goal g^{e}, the real goal g^{e} of a multitude of real goals G^{e} with a probability p(g^{e}) and an initial state s₀ with a probability of p(s₀) are sampled. The real goals g^{e} of the multitude of real goals G^{e} are environmental goals like desired position and orientation of an object which has to be manipulated by a robot arm. The initial state s₀ comprises the initial state like the initial position and orientation of the robot arms and all its joints.

In the step of sampling 2 an action aₜ, an action aₜ from the single-goal conditioned behaviour policy é that is represented by a Universal Value Function Approximator (UVFA) is sampled. The actions aₜ lead from the current state sₜ to the next state sₜ₊₁. The states sₜ comprise two sub-vectors, one achieved goal state s^{g} (e.g. position and orientation of the object being manipulated) and one context state s^{c} (s=(s^{g}∥s^{c})). An achieved goal g^{s} can be represented by a state and, thus, the achieved goal states can be written g^{s}=s^{g} UVFA essentially generalises the value functions (Q-functions) to multiple achieved goal states g^{s} where Q-values depend not only on state-action pairs (sₜ, aₜ), but also on the achieved goal states g^{s}.

In the step of stepping 3 the environment, the environment is stepped for a new state sₜ₊₁ with the sampled action aₜ.

In the step of updating 4 the replay buffer [symbol] , the replay buffer [symbol] that comprises a distribution p(ô^{g}) of goal state trajectories ô^{g} is updated with the current state sₜ and the current action aₜ. The goal state trajectories ô^{g} contain pairs of states sₜ from a multitude of states Sₜ and corresponding actions aₜ from a multitude of actions Aₜ.

In the step of constructing 5 the prioritised sampling distribution or rather proposal probability density function q(ô^{g}), the prioritised sampling distribution q(ô^{g}) is stepped with a higher entropy [symbol] _{q}(Ô^{g}) than the distribution p(ô^{g}) of goal state trajectories ô^{g} in the replay buffer [symbol] . Goal state trajectories ô^{g} with a lower probability are chosen more likely due to the prioritised sampling distribution q(ô^{g}). This leads to a uniform selection of goal state trajectories ô^{g}.

In the step of sampling 6 the goal state trajectories ô^{g}, the goal state trajectories ô^{g} are sampled with the prioritised sampling distribution q(ô^{g}) and a current density model Ö (q(ô^{g}|Ö)).

In the step of updating 7 the single-goal conditioned behaviour policy é, the single-goal conditioned behaviour policy é is updated to a maximum of an Energy [symbol] _{q} of a reward r for the states Sₜ and real goals G^{e} (max [symbol] _{q} [r(Sₜ, G^{e})]).

After the previous steps 2 to 7 are iteratively executed for each episode of the current epoch fe2, in the step of updating 8 the density model Ö, the density model Ö is updated for each epoch fe1.

All iterative steps are executed as long as the computer-implemented method has not converged. The method may converge to the optimal policy and/or until a predefined criterion is fulfilled (e.g. a number of epochs). This is checked (y: yes/n: no) 9 after each epoch or before a new epoch is started. For example, a criterion for convergence may be a simple upper limit C of epochs, for example C=200. The upper limit C is preferably between 50 to 200.

In FIG. 3 a flow-chart of the steps 2 to 6 of each episode of each epoch of the training and the step 8 of each epoch of the training with the with computer-implemented method or computer program of FIGS. 1 and 2 is schematically depicted (step 7 is not depicted in FIG. 3).

In each episode of each epoch the agent 10 (AI system) samples an action aₜ from the from the single-goal conditioned behaviour policy é represented as UVFA (step 2).

Then the environment 20 is stepped with the sampled action aₜ from the current state sₜ (e.g. current position and orientation of the object being manipulated and of the robot arm used for manipulation) to the next state sₜ₊₁ (step 3).

Based on the sampled action aₜ and the state sₜ the replay buffer [symbol] is updated (step 4).

Afterwards the prioritised sampling distribution or rather proposal probability density function q(ô^{g}) with higher entropy [symbol] _{q}(Ô^{g}) than the distribution p(ô^{g}) of goal state trajectories ô^{g} in the replay buffer [symbol] is constructed (step 5).

With the constructed prioritised sampling distribution q(ô^{g}) the goal state trajectories ô^{g} in the replay buffer [symbol] are sampled (step 6).

The sampled goal state trajectories ô^{g}, the new state sₜ₊₁ (state for the next iteration/episode) and the corresponding action aₜ are provided to the agent 10 for gaining “new experience”. Further, the single-goal conditioned behaviour policy é is updated to max [symbol] _{q} [r(Sₜ, G^{E})] (step 7 not depicted in FIG. 3).

After each episode of the current epoch the density model Ö of the agent 10 is updated (step 8).

The steps 2 to 8 are iteratively repeated as described above for each epoch of the training. After the method has converged, no further epoch of the training is started (by sampling 1 a new real goal g^{e} and a new initial state s₀, step 1).

In FIG. 4 a diagram of a performance test of the computer-implemented method according to the first aspect of the present invention schematically shown in FIGS. 1 to 3 is schematically depicted. The mean success rate MSR for “Push” PU, “Pick & Place” PI, “Slide” SL, “Egg” EG, “Block” BL and “Pen” PE is plotted over the amount of epochs used for training.

The performance of the method according to the present invention (MER multi-goal RL method) has been tested on a variety of simulated robotic tasks (i.e. OpenAI Gym: Push, Pick & Place, Slide, Egg, Block and Pen) and compared with state of the art methods as baselines, including DDPG and HER. The most similar method to MER multi-goal RL seems to be Prioritised Experience Replay (PER) (combined with DDPG(+HER)). In the experiments, first the performance improvement of MER multi-goal RL has been compared to DDPG with/without HER and to PER (with DDPG with/without HER). Afterwards, the time-complexity of MER multi-goal RL has been compared to DDPG(+HER) and to PER(+DDPG(+HER)). As will be subsequently described in detail MER multi-goal RL improves performance with much less computational time than DDPG(+HER) and PER.

A principle difference between MER multi-goal RL and PER is that PER uses TD-errors, while MER multi-goal RL is based on the entropy.

To test the performance difference among methods including DDPG, PER+DDGP and MER multi-goal RL (MERmgRL)+DDGP, the experiment has been run in the three robot arm environments of OpenAI Gym. The DDPG has been used as the baseline because the robot arm environment is relatively simple. In the more challenging robot hand environments the DDPG+HER has been used as the baseline and the performance among DDPG+HER, PER+DDPG+HER, and MER multi-goal RL+DDPG+HER has been tested. To combine PER with HER, the TD-error of each transition has been calculated based on the randomly selected achieved goals. Then the transitions with higher TD-errors have been prioritised for replay. The mean success rates have been compared. Each experiment has been carried out with 5 random seeds and the shaded areas in FIG. 4 represent the standard deviation. The learning curve with respect to training epochs is shown in FIG. 4. For all experiments, 19 CPUs have been used and the agent has been trained for 200 epochs. After training, the best-learned policy has been used for evaluation and it has been tested in the environment. The testing results are the mean success rates. A comparison of the performances along with the training time is shown in the subsequent table.

| Task: | Push | | Pick & Place | | Slide | |
|---|---|---|---|---|---|---|
| Method: | success | time | success | time | success | time |
| DDPG | 99.90% | 5.52 h | 39.34% | 5.61 h | 75.67% | 5.47 h |
| PER + DDPG | 99.94% | 30.66 h | 67.19% | 25.73 h | 66.33% | 25.85 h |
| MERmgRL | 99.96% | 6.76 h | 76.02% | 6.92 h | 76.77% | 6.66 h |
| Task: | Egg | | Block | | Pen | |
| Method: | success | time | success | time | success | time |
| DDPG + HER | 76.19% | 7.33 h | 20.32% | 8.47 h | 27.28% | 7.55 h |
| PER + DDPG + | 75.46% | 79.86 h | 18.95% | 80.72 h | 27.74% | 81.17 h |
| HER | | | | | | |
| MERmgRL | 81.30% | 17.00 h | 25.00% | 19.88 h | 31.88% | 25.36 h |

From FIG. 4, it can be seen that MER multi-goal RL (MERmgRL) converges faster in all six tasks than both the baseline and PER. The agent trained with MER multi-goal RL also shows a better performance at the end of the training, as shown in the table. Further, in the table it can be seen that the training time of MER multi-goal RL lies in between the baseline and PER. To be more specific, MER multi-goal RL consumes much less computational time than PER does, as no TD-errors are sampled. For example in the robot arm environments, on average MER multigoal RL consumes about 1.2 times the training time of DDPG. In comparison, PER*DDPG consumes about 5 times the training time as DDPG does. In this case, MER multi-goal RL is 4 times faster than PER. Compared to PER, MER multi-goal RL is much faster in computational time because it only updates the goal state trajectory density once per epoch. Due to this reason, MER multi-goal RI, is much more efficient than PER in computational time and can be easily combined with any multi-goal RL method, such as DDPG and HER. The table shows that baseline methods with MER multi-goal RL give a better performance in all six tasks. The improvement goes up to 39.34 percentage points compared to the baseline methods. The average improvement over the six tasks is 9.15 percentage points. It can be seen that MER multi-goal RL is a simple yet effective method, and it improves state-of-the-art methods.

In FIG. 5 a diagram of a sample-efficiency test of the computer-implemented method according to the first aspect of the present invention schematically shown in FIGS. 1 to 3 is schematically depicted. The amount of trainings samples TS for “Push” PU, “Pick & Place” PI, “Slide” SL, “Egg” EG, “Block” BL and “Pen” PE is plotted over the mean success rate MSR.

To compare the sample-efficiency of the baseline and MER multi-goal RL, the number of training samples needed for a certain mean success rate has been compared. The comparison is shown in FIG. 5. From FIG. 5, in the FetchPush-v0 environment, it can be seen that for the same 99% mean success rate, the baseline DDPG needs 273,600 samples for training, while MER multi-goal RI, only needs 112,100 samples. In this case, MER multi-goal RL is more than twice (2.44) as sample-efficient as DDPG. Similarly, in the other five environments, MER multi-goal RI, improves sample-efficiency by factors around one to three. In conclusion, for all six environments, MER multi-goal RL is able to improve sample-efficiency by an average factor of two (1.95) over the baseline's sample-efficiency.

In FIG. 6 a diagram of TD-errors during training with the computer-implemented method according to the first aspect of the present invention schematically shown in FIGS. 1 to 3 is schematically depicted. The TD-Error TDE for “Egg” EG, “Block” BL and “Pen” PE is plotted over complementary trajectory density CTD.

To further understand why maximum entropy in goal space facilitates learning, it is looked into the TD-errors during training. The correlation between the complementary predictive density p̅(ô^{g}|Ö), equation 11, and the TD-errors of the goal state trajectory is investigated. The Pearson correlation coefficients, i.e., Pearson's r, between the density p̅(ô^{g}|Ö) and the TD-errors of the goal state trajectory are 0.63, 0.76, and 0.73, for the hand manipulation of egg, block, and pen tasks, respectively. The plot of the Pearson correlation is shown in FIG. 6. The value of Pearson's r is between 1 and −1, where 1 is total positive linear correlation, 0 is no linear correlation, −1 is total negative linear correlation. It can be seen that the complementary predictive density is correlated with the TD-errors of the trajectory with an average Pearson's r of 0.7. This proves that the agent learns faster from a more diverse goal distribution. Under-represented goals often have higher TD-errors. Therefore, it is helpful to maximise the goal entropy and prioritise the underrepresented goals during training.

In FIG. 7 an embodiment of the computer-readable medium 20 according to the third aspect of the present invention is schematically depicted.

Here, exemplarily a computer-readable storage disc 20 like a Compact Disc (CD), Digital Video Disc (DVD), High Definition DVD (HD DVD) or Blu-ray Disc (BD) has stored thereon the computer program according to the second aspect of the present invention and as schematically shown in FIGS. 1 to 3. However, the computer-readable medium may also be a data storage like a magnetic storage/memory (e.g. magnetic-core memory, magnetic tape, magnetic card, magnet strip, magnet bubble storage, drum storage, hard disc drive, floppy disc or removable storage), an optical storage/memory (e.g. holographic memory, optical tape, Tesa tape, Laserdisc, Phasewriter (Phasewriter Dual, PD) or Ultra Density Optical (UDO)), a magneto-optical storage/memory (e.g. MiniDisc or Magneto-Optical Disk (MO-Disk)), a volatile semiconductor/solid state memory (e.g. Random Access Memory (RAM), Dynamic RAM (DRAM) or Static RAM (SRAM)), a non-volatile semiconductor/solid state memory (e.g. Read Only Memory (ROM), Programmable ROM (PROM), Erasable PROM (EPROM), Electrically EPROM (EEPROM), Flash-EEPROM (e.g. USB-Stick), Ferroelectric RAM (FRAM), Magnetoresistive RAM (MRAM) or Phase-change RAM).

In FIG. 8 an embodiment of the data processing system 30 according to the fourth aspect of the present invention is schematically depicted.

The data processing system 30 may be a personal computer (PC), a laptop, a tablet, a server, a distributed system (e.g. cloud system) and the like. The data processing system 30 comprises a central processing unit (CPU) 31, a memory having a random access memory (RAM) 32 and a non-volatile memory (MEM, e.g. hard disk) 33, a human interface device (HID, e.g. keyboard, mouse, touchscreen etc.) 34 and an output device (MON, e.g. monitor, printer, speaker, etc.) 35. The CPU 31, RAM 32, HID 34 and MON 35 are communicatively connected via a data bus. The RAM 32 and MEM 33 are communicatively connected via another data bus. The computer program according to the second aspect of the present invention and schematically depicted in FIGS. 1 to 3 can be loaded into the RAM 32 from the MEM 33 or another computer-readable medium 20. According to the computer program the CPU executes the steps 1 to 8 of the computer-implemented method according to the first aspect of the present invention and schematically depicted in FIGS. 1 to 3. The execution can be initiated and controlled by a user via the HID 34. The status and/or result of the executed computer program may be indicated to the user by the MON 35. The result of the executed computer program may be permanently stored on the non-volatile MEM 33 or another computer-readable medium.

In particular, the CPU 31 and RAM 33 for executing the computer program may comprise several CPUs 31 and several RAMs 33 for example in a computation cluster or a cloud system. The HID 34 and MON 35 for controlling execution of the computer program may be comprised by a different data processing system like a terminal communicatively connected to the data processing system 30 (e.g. cloud system).

Although specific embodiments have been illustrated and described herein, it will be appreciated by those of ordinary skill in the art that a variety of alternate and/or equivalent implementations exist. It should be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing at least one exemplary embodiment, it being understood that various changes may be made in the function and arrangement of elements described in an exemplary embodiment without departing from the scope as set forth in the appended claims and their legal equivalents. Generally, this application is intended to cover any adaptations or variations of the specific embodiments discussed herein.

In the foregoing detailed description, various features are grouped together in one or more examples for the purpose of streamlining the disclosure. It is understood that the above description is intended to be illustrative, and not restrictive. It is intended to cover all alternatives, modifications and equivalents as may be included within the scope of the invention. Many other examples will be apparent to one skilled in the art upon reviewing the above specification.

Specific nomenclature used in the foregoing specification is used to provide a thorough understanding of the invention. However, it will be apparent to one skilled in the art in light of the specification provided herein that the specific details are not required in order to practice the invention. Thus, the foregoing descriptions of specific embodiments of the present invention are presented for purposes of illustration and description. They are not intended to be exhaustive or to limit the invention to the precise forms disclosed; obviously many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated. Throughout the specification, the terms “including” and “in which” are used as the plain-English equivalents of the respective terms “comprising” and “wherein,” respectively. Moreover, the terms “first,” “second,” and “third,” etc., are used merely as labels, and are not intended to impose numerical requirements on or to establish a certain ranking of importance of their objects. In the context of the present description and claims the conjunction “or” is to be understood as including (“and/or”) and not exclusive (“either . . . or”).

1. A computer-implemented method of training artificial intelligence, AI, systems, comprising the iterative step of:
sampling a real goal g^{e} of a multitude of real goals G^{e} with a probability p(g^{e}) and an initial state s₀ with a probability of p(s₀);
and for each episode of each epoch of the training the iterative steps of:
sampling an action aₜ from a single-goal conditioned behaviour policy é that is represented by a Universal Value Function Approximator, UVFA;
stepping an environment for a new state sₜ₊₁ with the sampled action aₜ;
updating an replay buffer [symbol] that comprises a distribution p(ô^{g}) of goal state trajectories ô^{g} with the current state sₜ and the current action aₜ, wherein the goal state trajectories ô^{g} contain pairs of states sₜ from a multitude of states Sₜ and corresponding actions aₜ from a multitude of actions Aₜ;
constructing a prioritised sampling distribution q(ô^{g}) with a higher entropy [symbol] _{q}(Ô^{g}) than the distribution p(ô^{g}) of goal state trajectories ô^{g} in the replay buffer [symbol] ;
sampling the goal state trajectories ô^{g} with the prioritised sampling distribution q(ô^{g}) and a current density model Ö, q(ô^{g}|Ö); and
updating the single-goal conditioned behaviour policy é to an maximum of an Energy [symbol] _{q} of a reward r for the states Sₜ and the real goals G^{e}, max [symbol] _{g} [r(Sₜ, G^{e})];
and after each episode for each epoch of the training the step of:
updating the density model Ö;
while the computer-implemented method has not converged.

2. The computer-implemented method according to claim 1, wherein the step of updating the goal conditioned behaviour policy é is based on a Deep Deterministic Policy Gradient, DDPG, method and/or on a Hindsight Experience Replay, HER, method.

3. The computer program comprising instructions which, when the program is executed by a computer, cause the computer to carry out the steps of the method according to claim 1.

4. The computer-readable medium having stored thereon the computer program according to claim 3.

5. A data processing system comprising means for carrying out the steps of the method according to claim 1.
